(19) United States
(12) Patent Application Publication
(10) Pub. No.: US 2009/0167188 A1
(43) Pub. Date: Jul. 2, 2009

(54) METHOD AND DEVICE FOR CONTROLLING THE LIGHT FUNCTIONS IN FRONT HEADLAMPS FOR ROAD VEHICLES

(75) Inventors: Friedrich Mueller, Magstadt (DE); Volker Oltmann, Calw (DE); Juergen Seekircher, Ostfildern (DE); Bernd Woltermann, Fellbach (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/281,277

(22) PCT Filed: Mar. 1, 2007
(86) PCT No.: PCT/EP2007/001768

§ 371 Date: Aug. 29, 2008

(30) Foreign Application Priority Data
Mar. 3, 2006 (DE) 10 2006 010 455.2
May 10, 2006 (DE) 10 2006 022 022.6

(51) Int. Cl. B60Q 1/14; B60Q 1/08

(52) U.S. Cl. 315/82; 362/465

(57) ABSTRACT

Future vehicle headlamps will provide light functions, such as, for example, town light, country road light, motorway light, full beam, poor weather light, etc. A method and a device is therefore provided with which the light functions of vehicle headlamps are controlled in a reliable manner. The device essentially comprises front headlamps with a dipped headlight and full beam, and at least one variable actuator with which different light functions can be realized. In order to select a light function, the variable actuator is set to a predetermined, fixed position. In this case, it is not possible to select a light function in the region between the dipped headlight and the full beam, there being no means of locking the actuator in the intermediate region between the position of the actuator for the dipped headlight and the position for full beam. Only a light function which is matched to the driving situation and can be selected in a reliable manner is therefore possible.

The invention relates to a method and a device for controlling the light functions in front headlamps for road vehicles.

In contrast to the vehicle headlamps which are used today, and which comprise only a dipped headlight function and a full beam function, the intention is that in future the headlamps used in road vehicles will permit lighting which is adapted to a wide variety of driving situations. Adaptive light distribution means are used to provide light functions, such as, for example, a town light, country road light, freeway light, full beam, poor weather light etc. The intention is to provide the driver with the best possible view of the surroundings in front of the road vehicle. When vehicles travel in traffic in the light conditions experienced, for example, in poor weather, at dusk or in the night, other road users can be dazzled by the vehicle's own lighting. In modern vehicles with bright vehicle headlamps, such as for example a xenon light, the dazzling effect in such a case may be particularly severe. For this reason, when the light function which is most suitable for the current driving situation is selected, other influencing variables such as, for example, the presence of other road users and environmental influences also have to be taken into account. In order to relieve the stress on the driver, an automatic selection of the light function is therefore desirable.

DE 102004006133 A1 discloses a device and a method for automatically controlling the beam width in a motor vehicle, means being provided for detecting oncoming vehicles and vehicles traveling ahead. As a function of such a detection, switching over from dipped headlight to full beam occurs or the dipped headlight is adjusted into a lateral or vertically changed position with a relatively large or relatively small beam width.

The technical information “Licht-Scheinwerfer” from Hella KGaA Hueck & Co. (http://www.hella.com/produktion/HellaDE/ebSite/MiscContent/Download/AutoIndustrie/Licht/TIScheinwerfe_D_TT-18.pdf) presents driving-situation-dependent illumination of the roadway by means of a pivotable light projection module with variable xenon light distribution. In this context, the following light functions are implemented by means of a flank roller: town light, country road light, freeway light, full beam and poor weather light.

DE 10344174 A1 presents a headlamp for vehicles comprising a light source and a light-guiding unit for generating a predefined light distribution. The light-guiding unit has a deflection face with a plurality of micro mirrors which can be actuated independently of one another. Possible light distributions which can be generated are dipped headlight, full beam, town light, fog light, freeway light, display light etc.

DE 102004034838 A1 presents a headlamp system for shaping the light which is emitted by a single light source to form a full beam and a dipped headlight beam. The light source has here a coherent light emission zone for supplying light for the full beam and dipped headlight beam. The headlamp system permits both switching over between the full beam and dipped headlight and control of the beam width of the dipped headlight. A first diaphragm is located in the beam path of the full beam, which diaphragm has a plurality of intermediate positions between a maximum blocking position and a transmitting position. Furthermore, a second diaphragm is provided for blocking a lateral part of the dipped headlight beam or full beam. The headlamp system is controlled on the basis of image information from a surroundings-sensing system, with vehicles located in the surroundings also being taken into account within the scope of the control process.

DE 69709200T2 describes a vehicle headlamp with a single light source for dipped headlight and full beam. A plurality of actuators of the vehicle headlamp provide the possibility of adapting the light function in this context. One or more actuators CR are provided here for switching over between the dipped headlight and the full beam, with the switching over occurring by means of at least one linear actuating element. The at least one linear actuating element carries out here a translatory movement which brings about a change in position at the reflector of the vehicle headlamp by means of a rotatable rod. A further actuator CD is used to take into account dynamic changes in position of the vehicle when the light is set, with the height of the light beam being adapted as a function of the loading of the vehicle and/or of the state of the road. Furthermore, a manual correction device CM is provided with which the height and azimuth settings of the vehicle headlamp can be adjusted. By means of this manual correction device CM it becomes possible here, in particular, to select the beam width in such a way that it is located in the setting region between the setting for the dipped headlight and the setting for the full beam. Furthermore, it is possible to select an additional light function, with the light beam of the full beam being supplemented by a less wide light beam which is concentrated on the axis of the roadway.

The invention is based on the object of providing a method for controlling the light functions in front headlamps for road vehicles and a device for using the method according to the preambles of Patent claims 1 and 12, with which a light function which is adapted to the driving situation can be selected in a reliable way.

The object is achieved according to the invention by means of a method and a device having the features of Patent claims 1 and 12. Advantageous refinements and developments are presented in the subclaims.

According to the invention, method for controlling the light functions in front headlamps for road vehicles and a device for carrying out the method are provided. The device comprises essentially the front headlamps with a dipped headlight and a full beam as well as at least one variable actuator for the front headlamps, with which one or more light functions can be respectively implemented. Within the scope of the method according to the invention, the at least one variable actuator of the front headlamps is set to a predetermined fixed position in order to select a light function. In an inventive way, in this context the selection of a light function with a beam width in the region between the dipped headlight and the full beam is not possible, wherein there is no means of locking the actuator in the intermediate region of the position of the actuator for the dipped headlight and the position for the full beam. This makes it possible for the first time to make a reliable selection of a light function which is adapted to the driving situation. Since the actuator is not locked in the intermediate region of the position of the actuator for the dipped headlight and the position for the full beam, only light functions of the dipped headlight and of the full beam can advantageously be selected. As a result, the front headlamps cannot be set permanently to positions which are located in the region between the dipped headlight and the full beam. It is highly advantageous that when the invention is used the driver is clearly informed in a particularly reliable way as to whether the dipped headlight or the full beam is currently activated. For example, an active full beam is indicated to the driver by the activation of a blue LED display in the vehicle cockpit, while in the cases in which a light function of the dipped headlight is currently selected and the full beam is inactive, the blue LED display in the vehicle cockpit is inactive.

In the context of this invention, fixed positions for the selection of a light function are not provided in the region between the dipped headlight and the full beam. In the context of this invention, fixed positions are understood here to mean not only mechanical fixed positions but also fixedly defined electrical control states or control variables. The actuator for the full beam therefore cannot be locked or permanently set in the intermediate region of the position of the actuator for the dipped headlight and the position for the full beam. In a particularly preferred inventive fashion, the transition between the dipped headlight and the full beam occurs erratically here. The erratic, direct transition can occur here either from any desired light function of the dipped headlight to any desired light function of the full beam or conversely from any desired light function of the full beam to any desired light function of the dipped headlight. In the intermediate region, no fixed positions for light functions are possible here. In conjunction with this invention, the term dipped headlight has been selected for the description of a close-range light, the dipped headlight here having a plurality of light functions. Said light is, for example, a town light, country road light, freeway light or a poor weather light. The full beam can comprise a plurality of light functions here, for example different full beam gradations (for example gradations I, II and III) within the full beam. The individual light functions are implemented here by changing the beam width, light distribution, light intensity, color of the light and/or orientation of the light rays. A further light function is, for example, a left/right switching operation, with which adaptation to traffic on the left and respectively on the right is possible. The front headlamps which are used in conjunction with this invention can comprise either only a single light source or else a plurality of light sources. It is therefore possible to just use a single light source to implement a plurality of light functions of the dipped headlight and also a plurality of light functions for the full beam. For example, halogen headlamps, bi-xenon headlamps, LED headlamps and headlamps with light guidance by means of micro mirrors are suitable here for use as front headlamps in conjunction with road vehicles.

In a further advantageous inventive fashion, the transition between the dipped headlight and the full beam occurs by means of a ramp. In this context, the beam width, light distribution, light intensity and/or the orientation of the light rays is adapted by the variable actuator of the front headlamps in such a way that the transition between the dipped headlight and the full beam does not occur erratically but rather continuously. The transition can occur here by means of the ramp either from any desired light function of the dipped headlight to any desired light function of the full beam, or conversely from any desired light function of the full beam to any desired light function of the dipped headlight. In the intermediate region of the position of the actuator for the dipped headlight and the position for the full beam, there is no locking means for the actuator here so that the beam width and/or light distribution and/or light intensity of the front headlamps are continuously varied in this intermediate region. In a further advantageous way, there a positive gradient which is selected as a function of the relative velocity between the driver's own vehicle and that of a road user who is approaching/traveling ahead. In this context, the gradient of the ramp characterizes the degree of change in the lighting situation as a result of the transition between the dipped headlight and the full beam as well as the time period within which the transition occurs. At a high relative velocity, a high gradient is preferably selected here with the result that the transition between the dipped headlight and the full beam occurs in a short time. In contrast, in the case of a low relative velocity and/or when the distance from another road user is large, a small gradient is selected for the ramp and the transition between the dipped headlight and the full beam occurs more slowly. In this context, the gradient of the ramp can be positive or negative depending on whether the transition is from the dipped headlight to the full beam or from the full beam to the dipped headlight, or whether another road user penetrates the dazzle region of the driver's own road vehicle or exits this region.

In conjunction with the invention there is also the possibility of a transition between the dipped headlight and the full beam occurring by means of at least one monotonously rising or monotonously falling function. The at least one function can be here either a monotonous function or a strictly monotonous function. Instead of linear ramps, other monotonous functions or strictly monotonous functions are preferably used if a nonlinear kinematic chain is actuated by means of a linear electric actuator or if the speed of change over time is not to be constant. Such functions are also implemented in order, for example, to achieve a desired subjective impression of brightness with a certain effect. In this context, changes between different functions are also possible during the actuating process, for example owing to a change to the driving situation and/or surrounding situation.

In one advantageous way, the at least one function is selected as a function of the relative velocity between the driver's own vehicle and that of a road user who is approaching/traveling ahead, wherein a scaling factor which is dependent on this relative velocity is provided for the transition time or transition velocity. For example, a scaling factor (s) is provided for the abscissa on which the transition time (t) is plotted in a diagram, with the result that, taking into account the relative velocity, the transition time is t₁=t·s.

Furthermore, it is possible in an advantageous way that, in addition to the light functions which are set by the predetermined fixed positions, further light functions are possible, wherein on the basis of a fixed position of a light function at least one parameter which changes the light function is varied. As a result, variable beam widths and light distributions are possible for the first time both within the dipped headlight and for the full beam, irrespective of predetermined, fixed positions for light functions. The at least one parameter for changing the light function is here a parameter which changes the light distribution, light intensity, color tone and/or the orientation of the light rays, preferably the beam width. This at least one parameter can be varied manually here by the driver and/or automatically by a request by a vehicle-internal system.

In a further advantageous inventive fashion, the transition between the dipped headlight and the full beam occurs on the basis of control of the beam width. The transition from any desired light function of the dipped headlight to any desired light function of the full beam or vice versa occurs here for example on the basis of a variation of the beam width of the front headlamps, and this does not require the use of any further parameters which change the light distribution and/or light intensity and/or light orientation and/or coloring of the light. As a result, in a particularly advantageous fashion it is possible that a light function of the dipped headlight is selected, for example, on the basis of a fixed position, and in addition the beam width control is used to control the beam width in such a way that the front headlamps are operated in a light function within the transition region between the dipped headlight and the full beam. In this context, a blue check light is not presented to the driver since the full beam is not activated by 100%. As it were, there is the possibility of selecting a light function of the full beam by means of a fixed position and additionally controlling the beam width in such a way that the front headlamps are operated in the transition region between the full beam and the dipped headlight. A blue check light is not presented to the driver in this context either since the full beam is not activated by 100%. In contrast, a blue check light is presented if a light function of the full beam is selected and the full beam is activated by 100%. In this context, in the case of the full beam a plurality of light functions with, for example, different beam widths and/or light distributions are possible. Alternatively or additionally to the transition on the basis of control of the beam width, the transition between the dipped headlight and the full beam can also occur on the basis of diaphragm adjustment. In this context, modern vehicle headlamps provide the possibility of infinitely variable diaphragm adjustment.

Furthermore, in the context of the invention it is advantageous that a light function is selected on the basis of a driver's input and/or on the basis of a request by vehicle-internal systems. In this context, the driver uses a suitable input means for selecting the light function which is most suitable for the current driving situation according to his own sensory impressions. For example, a light and/or a steering column switch is suitable as input means here. In this context, in addition to mechanical switches, any desired other electronic input means, for example a voice-activated controller with automatic voice recognition, is, however, also suitable. Alternatively, or additionally to the selection by means of a driver's input, it is, however, also possible for light functions to occur on the basis of a request by one or more vehicle-internal systems. For example, there may be an automatic light control by means of a brightness sensor or an additional turning light which is automatically activated by a vehicle-internal system when there is an intention to turn the vehicle and at the same time a degree of steering lock is adopted. In this context, in most cases priority is given to a selection by a driver's input over a selection by one or more vehicle-internal systems unless a light function is being selected for safety reasons, in which case priority can also be given to a selection by one or more vehicle-internal systems over a selection by a driver's input.

In one particularly preferred embodiment of the invention, the selection of a light function occurs on the basis of the presence and/or the position of a road user who is traveling ahead or of an oncoming road user and/or the distance from said road user and/or said road user's relative angle to the driver's own vehicle. In this context, the detection of the presence and/or the position of a road user is preferably based on an optical surroundings control system. By means of vertical control of the beam width in accordance with the position of the road user who is traveling ahead or the oncoming road user, dazzling of other road users by the driver's own front headlamps can be reliably prevented while at the same time the range of the dipped headlight is optimized. The visual detection of the position of an oncoming road user allows the bend in the bent light/dark boundary in a vehicle with dynamic bend lighting to be oriented horizontally in such a way that the roadway next to the oncoming vehicle is illuminated without dazzling this oncoming traffic. In order to avoid dazzling of other road users, the full beam is active only if no other road users are located in the dazzle region of the driver's own vehicle. The dazzle region of a road vehicle usually comprises here the region lying ahead of the road vehicle, with a range of approximately 400-500 meters. As soon as another road user is located in this region, a light function of the dipped headlight is automatically selected. Furthermore, the invention also prevents dazzling of other road users within the close-range light region, in which case, for example when the dipped headlight function is activated, the light/dark boundary is adapted automatically as a function of the distance and/or angle of road users who are traveling ahead or of oncoming road users, preferably by controlling the beam width and/or by varying a diaphragm of the front headlamps. In a further advantageous way, a light function can also be selected on the basis of the velocity of the driver's own vehicle.

Furthermore, it is advantageous if a plurality of light functions are available for selection as a function of the current traffic situation. The traffic situation may be determined here, for example, by sensing the surroundings using an imaging sensor system and/or by means of information from a navigation system. This information may comprise, for example, the traffic volume or the type of traffic area (for example town center area, freeway etc.) on which the vehicle is currently traveling. In a first mode it is possible in this context that, for example, the following light functions are available for selection—dipped headlight, freeway light, full beam. In a further mode, for example the following light functions are available for selection—dipped headlight, town light, country road light, freeway light. In addition to these light functions, further light functions are available at fixed positions, with the control of the beam width also being varied.

In a further advantageous refinement of the invention, the actuator of the front headlamp is one or more of the actuators mentioned below: a diaphragm, an optical mirror, a flank roller, a stepping motor for controlling the orientation of the headlamp, an actuator for controlling the beam width, light sources which can be actuated independently of one another (for example LEDs, gas pressure lamps, . . . ) or a control unit for increasing the luminous flux. Any desired beam widths and light distributions for a wide variety of light functions can therefore be implemented.

In a further advantageous inventive fashion, at least one surroundings sensor is provided with which other road users and/or ambient conditions are sensed. In this context, through suitable evaluation by means of a computer unit it is not only possible to detect road users as such, but also the road users which are sensed by means of the surroundings sensor system can also be differentiated automatically in terms of oncoming vehicles and vehicles traveling ahead. In addition the relative position, relative angle and relative velocity of the road users who are sensed by means of the surroundings sensor can also be determined automatically. However, ambient conditions such as, for example, the brightness of the surroundings of the vehicle or wetness on the roadway are also sensed by means of the at least one surroundings sensor. Said information may also comprise the profile of the road, in which case particularly bends and vertical bends are sensed. This information is then advantageously used in the selection of a suitable light function.

The surroundings sensor may also be a digital map and/or a unit for determining positions, for example a navigation system with a connected GPS receiver. It is therefore possible, for example, to determine the curvature of a bend lying ahead of the vehicle. The type of road, for example a road in a town, country road or freeway as well as the gradient of the roadway, can also be determined in this way.

In a particularly preferred refinement of the invention, the surroundings sensor is an image sensor and/or a distance sensor. For use in the surroundings of the vehicle, for example a camera, radar, lidar and ultrasound sensors are particularly suitable here. The evaluation is carried out here by means of image-processing algorithms using a computer unit. Numerous algorithms are already known for object recognition and object tracking, permitting other road users and their movement variables as well as further ambient conditions to be reliably determined.

In the context of the invention it is also of great advantage if at least one axle sensor and/or one surroundings sensor are provided for sensing a predefined setpoint value for the control of the beam width. There may be an additional surroundings sensor which is also provided for sensing other road users and further ambient conditions. However, the sensor may also be an independent surroundings sensor which is intended exclusively for controlling the beam width. For example, the beam width is varied as a function of the distance from another road user within the dipped headlight only on the basis of the information from the surroundings sensor. If no other road user is in the dazzle region of the driver's own vehicle, the full beam is then activated. It is possible here for the control of the beam width to be reset to a standard position during the transition from the dipped headlight to the full beam. However, there is, as it were, also the possibility that the control of the beam width is not reset immediately to a standard position but rather only after the system has been switched back from the full beam to the dipped headlight. This type of control is not restricted here to the beam width but rather is also used for other parameters which are suitable for selecting a light function. Additionally or alternatively it is possible, for example, to control the light intensity in the same way for this purpose. In this context, one or more axle sensors are used for sensing a predefined setpoint value for the control of the beam width in addition to or as an alternative to the surroundings sensor. When a suitable light function is being selected on the basis of the control of the beam width, it is therefore also possible to take into account load states, dynamic changes in the inclination of the vehicle owing to braking processes and acceleration processes as well as other road users.

Furthermore, a display unit is advantageously provided with which the currently used light function is indicated to the driver. This is preferably a visual display unit which is arranged in the dashboard of the vehicle cockpit. By means of the visual display unit it is indicated to the driver whether the close-range light or the full beam is currently activated. In the context of the invention it has proven valuable here that if the full beam is active a blue check light is activated on the visual display while when the close-range lighting is active, the blue check light is inactive. Alternatively or additionally to this, the visual display can also indicate to the driver which light function, such as for example “town light”, “freeway light” etc. is currently selected. The visual display may also be a multifunction display, in which case, in addition to the currently selected light function, the driver is also provided with an indication of the presence of other road users and with information about the distance and/or relative velocity of said road users with respect to the driver's own vehicle.

Furthermore, a means with which malfunctions of the headlamp are detected can be provided, in which case the malfunction is then compensated by control of the beam width. In this context, a malfunction may be, for example, a diaphragm which has become stuck or a headlamp roller which has become stuck.

It is also advantageous if at least one actuator is provided, with which the beam width is controlled when the full beam is activated or when the dipped headlight is activated. In this way, the beam width is actuated, for example, as a function of the distance from oncoming vehicles and/or from vehicles traveling ahead and/or as a function of the presence of vertical bends and dips in the road.

1. A method for controlling the light functions in front headlamps for road vehicles,
wherein a dipped headlight and a full beam, which each comprise one or more light functions, are provided,
wherein in order to select a light function one or more variable actuators of the front headlamps are set to a predetermined fixed position,
wherein the selection of a light function with a beam width in the region between the dipped headlight and the full beam is not possible,
and wherein there is no means of locking the at least one actuator in the intermediate region of the position of the at least one actuator for the dipped headlight and the position for the full beam.

2. The method as claimed in claim 1, wherein the transition between the dipped headlight and the full beam occurs erratically.

3. The method as claimed in claim 1, wherein the transition between the dipped headlight and the full beam occurs by means of a ramp.

4. The method as claimed in claim 3, wherein the ramp has a positive gradient which is selected as a function of the relative velocity between the driver's own vehicle and that of a road user who is approaching/traveling ahead.

5. The method as claimed in claim 1 wherein the transition between the dipped headlight and the full beam occurs by means of at least one monotonously rising or falling function.

6. The method as claimed in claim 5, wherein the at least one function is selected as a function of the relative velocity between the driver's own vehicle and that of a road user who is approaching/traveling ahead, wherein a scaling factor which is dependent on the relative velocity is provided for the transition time or transition velocity.

7. The method as claimed in claim 1, wherein, in addition to the light functions which are set by the predetermined fixed positions, further light functions are possible, wherein on the basis of a fixed position of a light function at least one parameter which changes the light function is varied.

8. The method as claimed in claim 1, wherein at least one parameter for changing the light function is a parameter which changes the beam width, light distribution, light intensity, color tone and/or the orientation of the light rays.

9. The method as claimed in claim 1, wherein the transition between the dipped headlight and the full beam occurs on the basis of control of the beam width.

10. The method as claimed in claim 1, wherein the transition between the dipped headlight and the full beam occurs on the basis of diaphragm adjustment.

11. The method as claimed in claim 1, wherein the light functions are a town light, country road light, freeway light, poor weather light, one or more light functions of a full beam or a left/right switching means.

12. The method as claimed in claim 1, wherein a light function is selected on the basis of a driver's input and/or on the basis of a request by one or more vehicle-internal systems.

13. The method as claimed in claim 1, wherein the selection of a light function occurs on the basis of the presence and/or the position of a road user who is traveling ahead or of an oncoming road user and/or the distance from said road user and/or said road user's relative angle to the driver's own vehicle.

14. The method as claimed in claim 1, wherein the selection of a light function occurs on the basis of the velocity of the driver's own vehicle.

15. The method as claimed in claim 1, wherein a plurality of light functions are available for selection as a function of the current traffic situation.

16. A device for controlling the light functions in front headlamps for road vehicles, comprising
front headlamps with a dipped headlight and a full beam, with which one or more light functions can be respectively implemented,
wherein at least one variable actuator of the front headlamps is set to a predetermined fixed position in order to select a light function,
and wherein a fixed position for the selection of a light function is not provided in the region between the dipped headlight and the full beam, in which case the at least one actuator cannot be locked in the intermediate region between the position for the dipped headlight and the position for the full beam.

17. The device as claimed in claim 16, wherein at least one actuator is one or more of the actuators mentioned below: a diaphragm, an optical mirror, a flank roller, a stepping motor for controlling the orientation of the headlamp, an actuator for controlling the beam width, a light source or light sources which can be actuated independently of one another or a control unit for increasing the luminous flux.

18. The device as claimed in claim 16, wherein at least one surroundings sensor is provided with which other road users and/or ambient conditions are sensed.

19. The device as claimed in claim 16, wherein the surroundings sensor is an image sensor and/or a distance sensor.

20. The device as claimed in claim 16, wherein the surroundings sensor is a digital map and/or a unit for determining positions.

21. The device as claimed in claim 16, wherein at least one axle sensor and/or one surroundings sensor are provided for sensing a predefined setpoint value for the control of the beam width.

22. The device as claimed in claim 16, wherein a display unit is provided with which the currently used light function is indicated to the driver.

23. The device as claimed in claim 16, wherein a means for detecting malfunctions of the headlamps is provided, wherein malfunctions are compensated for by controlling the beam width.

24. The device as claimed in claim 16, wherein at least one actuator is provided, with which the beam width is controlled when the full beam or dipped headlight is activated.
